(19) United States
(12) Patent Application Publication
(10) Pub. No.: US 2007/0104362 A1
(43) Pub. Date: May 10, 2007

(54) Face recognition method, and system using gender information

(75) Inventors: Wonjun Hwang, Seoul (KR); Seokcheol Kee, Seoul (KR); Gyutae Park, Anyang-si (KR); Jongha Lee, Hwaseong-si (KR); Haibing Ran, Beijing (CN)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/593,596

(22) Filed: Nov. 7, 2006

(30) Foreign Application Priority Data
Nov. 8, 2005 (KR) 10-2005-0106673

(51) Int. Cl. G06K 9/62; G06K 9/00

(52) U.S. Cl. 382/159; 382/118

(57) ABSTRACT

A face recognition method, medium, and system using gender. According to the method, the gender of different faces can be classified in a query facial image and a current target facial image. A training model can be selected depending on the gender classification result, and a feature vector of the query facial image and a feature vector of the current target facial image may be obtained using the selected training model. Next, the similarity between the feature vectors is measured and similarities are obtained for a plurality of target facial images, and the person of a target image having a largest similarity among the obtained similarities is recognized as the querier.

### CROSS-REFERENCE TO RELATED APPLICATIONS

This application claims the benefit of Korean Patent Application No. 10-2005-0106673, filed on Nov. 8, 2005, in the Korean Intellectual Property Office, the disclosure of which is incorporated herein in its entirety by reference.

### BACKGROUND OF THE INVENTION

1. Field of the Invention

An embodiment of the present invention relates to a face recognition method, medium, and system using gender information, and more particularly, to a method, medium, and system determining the gender of a query facial image and recognizing a face using the determined gender.

2. Description of the Related Art

Face recognition techniques include techniques for identifying a user using a given facial database with respect to one or more faces contained in a still image or a moving image. Since facial image data drastically changes depending on the pose or lighting conditions, it is difficult to classify data to take into consideration each pose or each lighting condition for the same person, i.e., the same class. Accordingly, high accuracy classification solution is desired. An example of such a widely used linear classification solution includes Linear Discriminant Analysis (referred to as LDA hereinafter).

Generally, the recognition performance or reliability for a female face is lower than that for a male face. Further, according to a training method, such as the LDA, a training model overfits variations such as expression changes held by samples of a training set. Since female facial images existing in a training set are frequently changing, e.g., due to changes in make-up or the wearing of differing accessories, facial images for the same female person may vary greatly, resulting in within-class scatter matrixes having to be more complicated. In addition, since the typical female face is very similar to an average facial image, compared to the typical male face, and as even different images of different female persons look similar, a between-class scatter matrix does not have a large distribution. Accordingly, the variance between male facial images has a greater influence on a training model than the variance between female facial images.

To overcome these problems, the inventors have found it desirable to separately train models with the separate training samples according to their genders and recognize the samples based on the recognized genders.

### SUMMARY OF THE INVENTION

An embodiment of the present invention provides a method, medium, and system capable of face recognition by first determining the gender of a person contained in a query image and then selecting a separate training model depending on the determined gender.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a method of recognizing a face, the method including classifying genders of at least one respective face in a query facial image and a current target facial image, selecting a training model based on the classifying of the genders, obtaining feature vectors of the query facial image and the current target facial image using the selected training model, measuring a similarity between the feature vectors, and obtaining similarities of a plurality of target facial images and recognizing a person of the query facial image as being a same person as an identified target image having a largest similarity among the obtained similarities.

To achieve at least the above and/or further aspects and advantages, embodiments of the present invention include a system for recognizing a face, the system including a gender classifying unit to classify genders of at least one respective face in a query facial image and a plurality of target facial images and to output a result of the gender classifying in terms of probabilities, a gender reliability judging unit to judge a reliability of a classified gender of the at least one respective face in the query facial image and/or the plurality of target facial images using a respective probability, a model selecting unit to select respective training models based on the gender classifying and the judged reliability, a feature extracting unit to extract feature vectors from the query facial image and the target facial images using the selected training models, and a recognizing unit to compare a feature vector of the query facial image and feature vectors of the target facial images to obtain similarities, and to recognize a person of the query facial image as being a same person as an identified target image having a largest similarity among the obtained similarities.

To achieve at least the above and/or still further aspects and advantages, embodiments of the present invention include at least one medium including computer readable code to control at least one processing element to implement a method including classifying genders of at least one respective face in a query facial image and a current target facial image, selecting a training model based on the classifying of the genders, obtaining feature vectors of the query facial image and the current target facial image using the selected training model, measuring a similarity between the feature vectors, and obtaining similarities of a plurality of target facial images and recognizing a person of the query facial image as being a same person as an identified target image having a largest similarity among the obtained similarities.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates an averaged image of male facial images and an identification power of the averaged image in a pixel domain;

FIG. 1 B illustrates an averaged image of female images and an identification power of the averaged image in a pixel domain;

FIGS. 2A through 2C illustrate basis images obtained by performing a Fisher linear discriminant on global facial images, male facial images, and female facial images, respectively;

FIG. 3 illustrates a gender-based face recognition system, according to an embodiment of the present invention;

FIG. 4 illustrates a gender-based face recognition method, according to an embodiment of the present invention;

FIG. 5 illustrates a Fisher linear discriminant analysis method, according to an embodiment of the present invention;

FIG. 6 illustrates exemplified images of five different persons selected from a database for face recognition, implemented in an embodiment of the present invention;

FIG. 7A illustrates a receiver operating feature (ROC) curve for simulation results of a query image, implementing an embodiment of the present invention;

FIG. 7B illustrates an enlarged ROC curve when false acceptance ratio (FAR) is 0.1% in the graph illustrated in FIG. 7A, implementing an embodiment of the present invention; and

FIG. 8 illustrates an accumulated recognition ratio of a rank, implementing an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

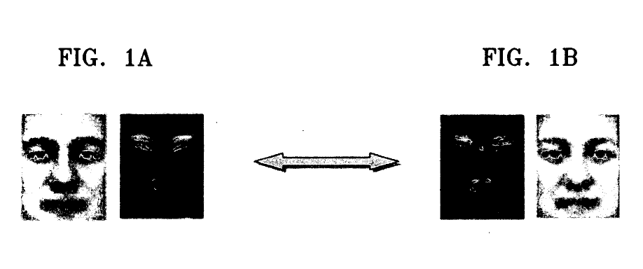

FIG. 1A illustrates an averaged image of male images and an identification power of the averaged image in a pixel domain, and FIG. 1B illustrates an averaged image of female images and an identification power of the averaged image in a pixel domain.

As shown by FIGS. 1A and 1B, the averaged image of the male face is different from that of the female face, and facial features that could be used to identify a female face during face recognition are different from facial features that could be used to identify a male face during face recognition. Particularly, features in the neighborhood of the eyebrows, nose, and mouth are conspicuously distinguished from other features between the respective images for female and mail faces.

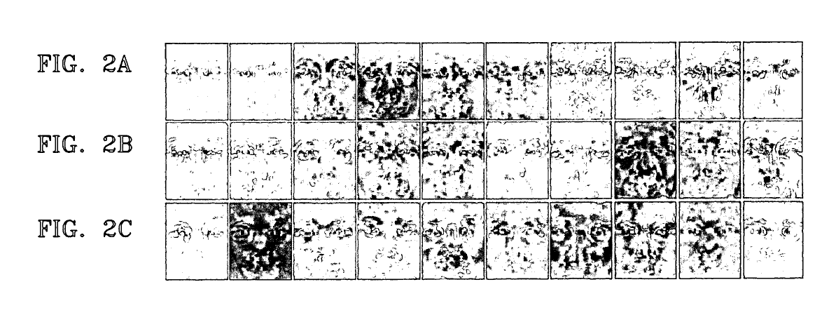

Similarly, FIG. 2A illustrates basis images obtained by performing a Fisher linear discriminant on global facial images, FIG. 2B illustrates basis images obtained by performing a Fisher linear discriminant on male facial images, and FIG. 2C illustrates basis images obtained by performing a Fisher linear discriminant on female facial images. Here, the global facial images are facial images that are mixed without discrimination between men and women. Referring to FIGS. 2A through 2C, it can be seen that the basis images have differences depending on their gender. Therefore, it has been found that different face models should be used depending on the gender when identifying the man or woman.

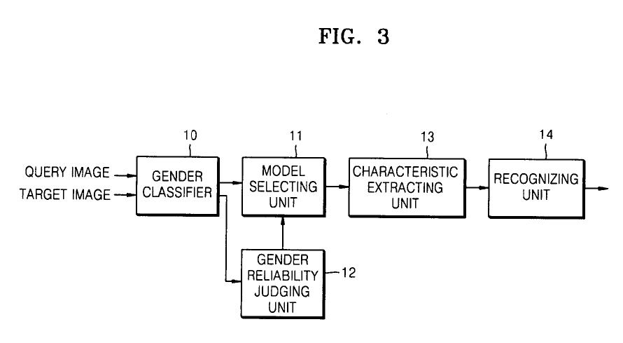

FIG. 3 illustrates a gender-based face recognition system, according to an embodiment of the present invention. The face recognition system may include a gender classifier 10, a model selecting unit 11, a gender reliability judging unit 12, a feature extracting unit 12, and a recognizing unit 14, for example.

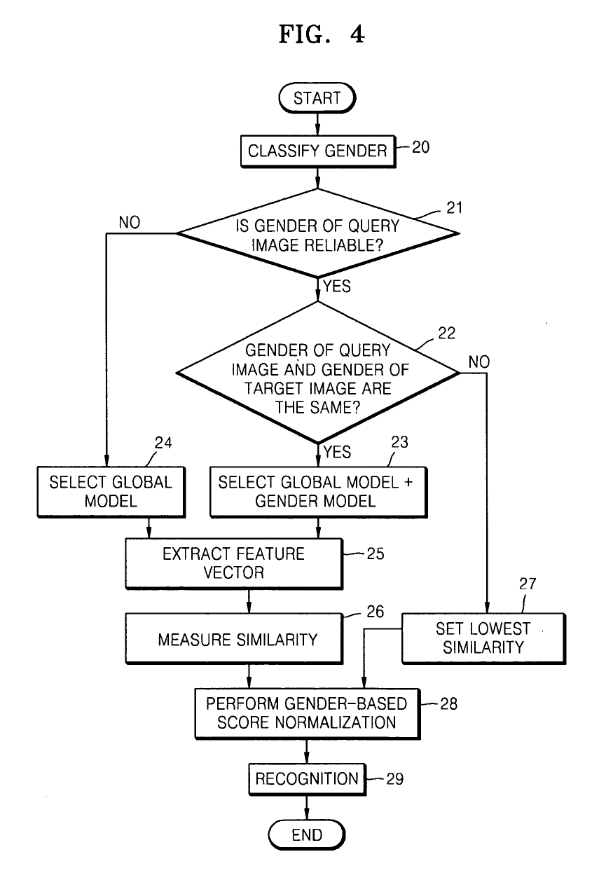

FIG. 4 illustrates a gender-based face recognition method, according to an embodiment of the present invention. An operation of the face recognition system of FIG. 3, will be described with reference to the FIG. 4, according to an embodiment of the present invention.

The gender of a query facial image may be classified, e.g., by the gender classifier 10, from target facial images, in operation 20. Here, the query facial image may be a facial image for an object to be recognized, and each of the target facial images may be one of a plurality of facial images previously stored in a database (not shown), for example.

The gender classification may be performed according to a classification algorithm according to any one of the conventional classifiers. Examples of the classifiers include neural networks, Bayesian classifiers, linear discriminant analysis (LDA), and support vector machines (SVMs), noting that alternative embodiments are equally available.

The gender classification result may be output as a probability, e.g., according to a probability distribution, and may be judged and output, identifying the query facial image as either a man or woman with reference to a discrimination value, e.g., a probability variable value having a maximum probability in the probability distribution. Here, the probability variable may include pixel vectors that are obtained from the query image or the target image and input to the classifier.

In an embodiment, the model selector 11 may reflect the gender reliability result, e.g., from the gender reliability judging unit 12, for selecting an appropriate face recognition model.

The classified gender of the query image may be judged for it's reliability, e.g., using the gender reliability judging unit 12, based on the gender classification probability, e.g., as output from the gender classifier 10, in operation 21. The classified gender may be judged to be reliable when the gender classification probability is less than a first value, for example, that is, the probability variable may be separated a second value or more from a central value. Here, the first and second values may be determined heuristically.

When the gender of the query image is judged to be reliable, it may be determined whether the genders of the query image and the target image, e.g., classified by the gender classifier 10, are the same, e.g., by the model selector 11, in operation 22. When the genders of the query image and the target image are the same, a global model and a model of the classified gender may be selected, e.g., by the model selector 11, in operation 23.

When the gender of the query image is judged not to be reliable, in operation 21, only the global model may be selected, e.g., by the model selector 10, in operation 24.

Here, the global model and the model for each gender may correspond previously trained models.

The models may be trained in advance via Fisher's LDA based on the target images stored in the database, for example. The target images can be classified into a global facial image group, a male facial image group, and a female facial image group, in order to train the models. Each of the models may be trained with the images contained in the corresponding group.

In addition, the target images may include a plurality of images for each individual, with the images that correspond to each individual making up a single class. Therefore, the number of individuals to be an object of the target image is the number of the classes.

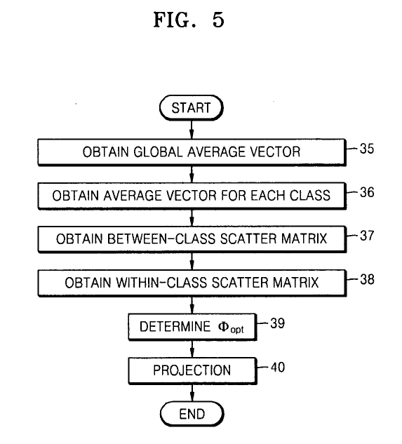

The aforementioned Fisher's LDA will now be described in greater detail with reference to FIG. 5. First, a global region average vector x̅ᵢ for input vectors x of all of the training images stored in the database may be obtained, in operation 35, and an average vector x̅ᵢ may be obtained for each class, in operation 36. Next, a between-class scatter matrix S_{B}, representing a variance between classes, may be obtained using the below Equation 1, for example.

$$\begin{matrix}Equation 1 \text{:} & \\ {S}_{B} = {\sum }_{i = 1}^{m} {N}_{i} ( {\overline{x}}_{i} - \overline{x} ) {( {\overline{x}}_{i} - \overline{x} )}^{T} & \end{matrix}$$

Here, m represents the number of classes, Nᵢ represents the number of training images contained in an i-th class, and T denotes a transpose.

A within-class scatter matrix S_{w}, which represents a within-class variance, can be obtained using the below Equation 2, for example.

$$\begin{matrix}Equation 2 \text{:} & \\ {S}_{W} = {\sum }_{i = 1}^{m} {\sum }_{x ∈ {X}_{i}} ( x - {\overline{x}}_{i} ) {( x - {\overline{x}}_{i} )}^{T} & \end{matrix}$$

Here, Xᵢ represents an i-th class.

A matrix Φₒₚₜ, satisfying the following object function may further be obtained from S_{B} and S_{W}, obtained using the above Equations 1 and 2, according to the following Equation 3, in operation 39, for example.

$$\begin{matrix}Equation 3 \text{:} & \\ {Φ}_{opt} = arg {max}_{Φ} \frac{\vert {Φ}^{T} {S}_{B} Φ \vert}{\vert {Φ}^{T} {S}_{W} Φ \vert} = [ \begin{matrix}{ϕ}_{1} & {ϕ}_{2} & … & {ϕ}_{k}\end{matrix} ] & \end{matrix}$$

Here, Φₒₚₜ, represents a matrix made up of eigenvectors of S_{B}S_{W}⁻¹. The Φₒₚₜ provides a projection space of k-dimension. A projection space of d-dimension where d<k may be obtained by performing a principal component analysis (PCA) (⊖) on the Φ_{opt.}

The projection space of d-dimension becomes a matrix including eigenvectors that correspond to d largest eigenvalues among the eigenvalues of S_{B}S_{W}⁻¹.

Therefore, projection of a vector (x- x̅) to the d-dimensional space can be performed using the below Equation 4, for example.
y=(ΦₒₚₜΘ)^{T}(x- x̅)=U^{T}(x- x̅) Equation 4:

According to an embodiment of the present invention, training of the models may be separately performed for the global facial image group (g=G), male facial image group (g=M), and female facial image group (g=F).

Between-class scatter matrix S_{Bg} and within-class scatter matrix S_{Wg} may be expressed by the below Equation 5, for example, depending on each of the models.

$$\begin{matrix}Equation 5 \text{:} & \\ {S}_{{B}_{g}} = {\sum }_{i = 1}^{{m}_{g}} {N}_{i} ( {\overline{x}}_{i} - {\overline{x}}_{g} ) {( {\overline{x}}_{i} - {\overline{x}}_{g} )}^{T} \\ {S}_{{W}_{g}} = {\sum }_{i = 1}^{{m}_{g}} {\sum }_{x ∈ {X}_{i , g}} ( x - {\overline{x}}_{i} ) {( x - {\overline{x}}_{i} )}^{T} & \end{matrix}$$

The training may be performed to obtain Φ_{optg} satisfying the below Equation 6, for example, for each of the model images.

$$\begin{matrix}Equation 6 \text{:} & \\ {Φ}_{optg} = arg {max}_{{Φ}_{g}} \frac{\vert {Φ}_{g}^{T} {S}_{{B}_{g}} {Φ}_{g} \vert}{\vert {Φ}_{g}^{T} {S}_{{W}_{g}} {Φ}_{g} \vert} & \end{matrix}$$

When the model selector 11 selects a model, the feature extracting unit 12, for example, may extract a feature vector y_{g} for the group, e.g., according to the above Equation 4, using Φ_{optg} for the selected model, in operation 25.

When the model selector 11 selects both the global model and the gender model, the feature vector may be extracted as follows, e.g., using Equation 4, by concatenating the global model with the gender model, according to the below Equation 7.

$$\begin{matrix}Equation 7 \text{:} & \\ {y}_{M}^{′} = ( \begin{matrix}{y}_{G} \\ {W}_{M} {y}_{M}\end{matrix} ) = ( \begin{matrix}{U}_{G}^{T} ( x - {\overline{x}}_{G} ) \\ {W}_{M} {U}_{M}^{T} ( x - {\overline{x}}_{M} )\end{matrix} ) \\ {y}_{F}^{′} = ( \begin{matrix}{y}_{G} \\ {W}_{F} {y}_{F}\end{matrix} ) = ( \begin{matrix}{U}_{G}^{T} ( x - {\overline{x}}_{G} ) \\ {W}_{F} {U}_{F}^{T} ( x - {\overline{x}}_{F} )\end{matrix} ) & \end{matrix}$$

Here, W_{g} represents a weight matrix for each gender model, the weight matrix W_{g}=rI (I is an identity matrix), and r² represents a ratio of a variance of an entire gender feature to a variance of an entire global feature.

The feature vector of the global model, among the extracted feature vectors, may perform a main role of the face recognition, and the feature vector of the gender model may provide features corresponding to each gender, thereby performing an auxiliary role in the face recognition.

Accordingly, the recognizing unit 14, for example, may calculate the similarity between the extracted feature vectors from the query image and the target image, in operation 26. At this point, when the gender of the query image and the gender of the target image are determined to not be the same, e.g., in the above operation 22, the similarity determination may be set such that the target image has the lowest similarity, in operation 27.

The similarity may be calculated by obtaining a normalized correlation between a feature vector y_{q} of the query image and a feature vector yₜ of the target image. The normalized correlation S may further be obtained from an inner product of the two feature vectors, as illustrated in the below Equation 8, and have a range [−1, 1], for example.

$$\begin{matrix}Equation 8 \text{:} & \\ S ( {y}_{q} , {y}_{t} \vert {g}_{q} = {g}_{t} ) = \frac{{y}_{q} \cdot {y}_{t}}{‖ {y}_{q} ‖ \cdot ‖ {y}_{t} ‖} & \end{matrix}$$

The recognizing unit 14 may obtain similarity between each of the target images and the query image through the above described process, select a target image having the largest similarity to recognize a querier in the query image as the person of the selected target image, in operation 29.

When the gender of the query image and the gender of the target image are determined to be the same, e.g., during the above process, the recognizing unit 14, for example, may further perform gender-based score normalization when calculating the similarity, in operation 28. An embodiment employs a score vector used for the gender-based score normalization as the similarity between the feature vector of the query image and the feature vector of each target image, for example.

Thus, the gender-based score normalization may be used for adjusting an average and a variance of the similarity depending on the gender, and for reflecting the adjusted average and variance into a currently calculated similarity. That is, target images having the same gender as that of the query image may be selected and normalized, and target images having the other gender may be set to have the lowest similarity and not included in the normalization.

When the number of target images whose gender is the same as that of the target image is N_{g}, an average mg and a variance σ_{g}² of the similarity of the target images may be determined using the below Equation 9, for example.

$$\begin{matrix}Equation 9 \text{:} & \\ {m}_{g} = \frac{1}{{N}_{g}} {\sum }_{i = 1 , {g}_{q} = {g}_{t}}^{{N}_{g}} {S}_{j} , {σ}^{2} = \frac{1}{{N}_{g}} {\sum }_{i = 1 , {g}_{q} = {g}_{t}}^{{N}_{g}} {( {S}_{j} - {m}_{g} )}^{2} & \end{matrix}$$

Here, g_{q} represents the gender of the query image, and gₜ represents the gender of the target images.

The similarities of the query image and the target images may be controlled, as illustrated in the below Equation 10, based on the average and variance calculated by Equation 9, for example.

$${S}_{j}^{′} ( {y}_{g} , {y}_{{t}_{j}} ) = \frac{{S}_{j} ( {y}_{g} , {y}_{{t}_{j}} ) - {m}_{g}}{{σ}_{g}}$$

Here, yₜ_{ⱼ} represents a feature vector of a j-th target image. The similarities controlled, as calculated by Equation 10, may be obtained for all of the target images, and the person of the target image having the largest similarity may be recognized as the person in the query image, in operation 29.

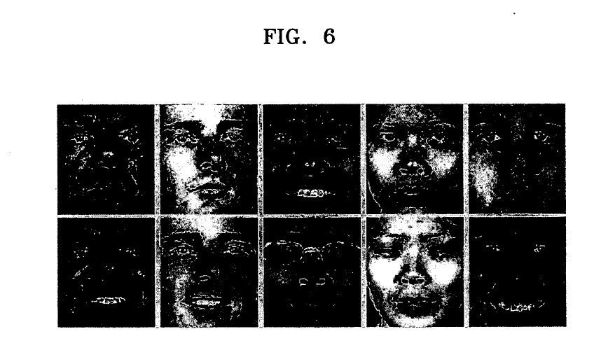

FIG. 6 illustrates an example containing images of five different people selected from a database for face recognition. A total of 12,776 images for 130 men and 92 women were selected from a face recognition database as a training model set used for training a facial model, and a total of 24,042 images for 265 men and 201 women were selected as a query image set and a target image set for a face recognition experiment. In the illustrated implemented embodiment, the query image set has been divided into four subsets to be simulated and a final result has been obtained by averaging the four subsets.

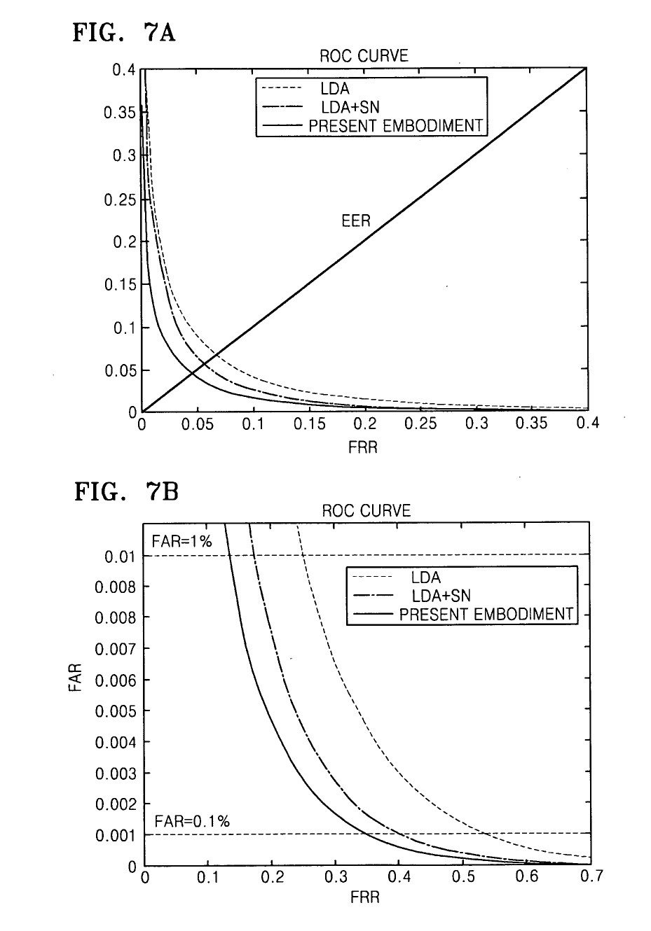

FIG. 7A illustrates simulation results of a query image, for the above embodiment implementation, using a Receiver Operating Character (ROC) curve.

Here, the ROC curve represents a False Acceptance Ratio (FAR) with respect to a False Rejection Ratio (FRR). The FAR means a probability of accepting an unauthorized person as an authorized person, and the FRR means a probability of rejecting an authorized person as an unauthorized person.

Referring to the graph of FIG. 7A, a plot EER represents a false recognition ratio for FAR=FRR, and referred when overall performance is considered. A plot LDA +SN represents the case where the score normalization is applied to a general LDA.

FIG. 7B is an enlarged view of a portion that corresponds to FAR=0.1%, i.e., EER=0.1% in the graph illustrated in FIG. 7A, in the above embodiment implementation. Referring to FIGS. 7A and 7B, the face recognition method, according to an embodiment of present invention, shows a resultant best performance. Particularly, referring to FIG. 7B, when the FAR reaches 1% or 0.1%, the smallest FRR was achieved.

Table 1 shows comparisons of recognition performances of LDA, LDA+SN, and the above embodiment of the present invention.

TABLE 1

| | VR | | CMC |
|---|---|---|---|
| | (FAR = 0.1%) | EER | (first) |
| LDA | 45.20% | 6.68% | 49.39% |
| LDA + SN | 59.54% | 5.66% | 49.39% |
| Present invention | 64.93% | 4.50% | 54.29% |

In Table 1, VR represents a verification ratio verifying authorized person as herself/himself, CMC (cumulative match features) represents a recognition ratio recognizing an authorized person as herself/himself. In detail, CMC indicates a measure at which rank a person's face in the query image is presented when the query image is given. That is, when the measure is 100%, at a rank 1, the person's face is determined to be contained in a first-retrieved image. Also, when the measure is 100%, at rank 10, the person's face is determined to be contained in a tenth-retrieved image.

Table 1 reveals that the VR and the recognition ratio, according to an embodiment of the present invention, are higher than those of the conventional art and that the ERR of this embodiment is lower than those of the conventional implementations.

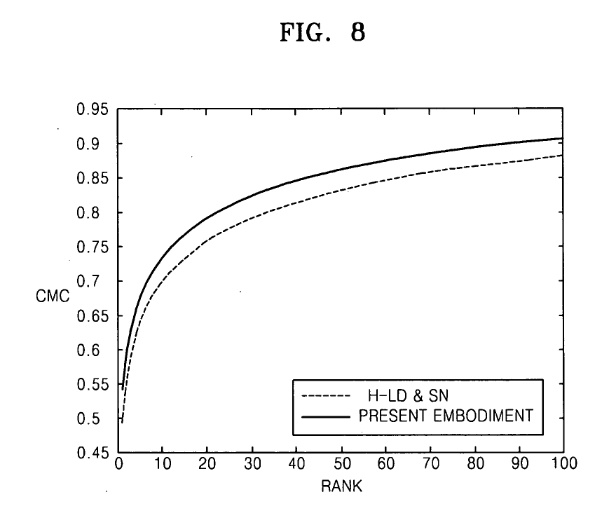

FIG. 8 illustrates CMC for a rank. FIG. 8 reveals that the recognition ratio of the above embodiment implementation is higher than that of the conventional art LDA+SN.

Thus, according to an embodiment of the present invention, since a feature vector can be extracted using a gender model, as well as the global model, a recognition ratio may be enhanced by reflecting the gender feature according to a determined gender, into the face recognition.

In addition, it is possible to prevent confusion caused by an image having a different gender by performing score normalization using gender information. Further, it is possible to perform more accurate normalization by obtaining an average and a variance of the same gender samples.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of recognizing a face, the method comprising:
classifying genders of at least one respective face in a query facial image and a current target facial image;
selecting a training model based on the classifying of the genders;
obtaining feature vectors of the query facial image and the current target facial image using the selected training model;
measuring a similarity between the feature vectors; and
obtaining similarities of a plurality of target facial images and recognizing a person of the query facial image as being a same person as an identified target image having a largest similarity among the obtained similarities.

2. The method of claim 1, wherein the classifying of the gender comprises:
outputting a result of the classifying of genders in terms of a probability using a classification algorithm being input the query facial image and the current target facial image; and
determining a gender of a face using a probability distribution representing the probability.

3. The method of claim 2, wherein the selecting of the training model comprises:
determining whether a gender of the query facial image is a same as a gender of the target facial image when a probability of the query facial image fails to meet a predetermined value; and
selecting a global model, irrelevant to the determined gender of the face, and one of a plurality of gender models corresponding to the determined gender.

4. The method of claim 3, wherein the global model is trained by updating a matrix having an object function for global images, irrelevant to a gender determination among the target images, such that the global model satisfies the object function of the global images, and the gender models are trained by updating matrixes having object functions for male images and female images, respectively, such that each of the gender models satisfies each of respective gender object functions.

5. The method of claim 4, wherein the obtaining of the feature vectors comprises:
projecting each of the trained matrixes into a space of a dimension lower than respective dimensions of the matrixes;
subtracting an average of the global images and an average of images that correspond to a selected gender from the query image and the current target image; and
operating images from which averages are subtracted with the projected matrixes.

6. The method of claim 5, wherein a feature vector that corresponds to an image having the selected gender, among the feature vectors, is weighted by a diagonal matrix having a weight.

7. The method of claim 6, wherein the weight is determined by a ratio of a feature variance of all gender images to a feature variance of all of the global images.

8. The method of claim 3, wherein the selecting of the training model further comprises, when the gender of the query facial image and the gender of the target facial image are not identical, setting a lowest similarity to the current target facial image.

9. The method of claim 3, wherein the selecting of the training model further comprises, when the probability of the query facial image meets the predetermined value, selecting the global models without the one gender model corresponding to the determined gender.

10. The method of claim 9, wherein the global model is trained by updating a matrix having an object function for global images, irrelevant to a gender determination among target images, such that the global model satisfies the object function of the global images.

11. The method of claim 10, wherein the obtaining of the feature vectors comprises:
projecting the trained matrix to a space of a dimension lower than a respective dimension of the matrix;
subtracting an average of the global images from the query image and the current target image; and
operating an image from which the average is subtracted with the projected matrix.

12. The method of claim 1, wherein the obtained similarities are measured by dividing an inner product of the feature vectors of the query facial image and the current target facial image by a product of magnitudes of feature vectors of the query facial image and the current target facial image.

13. The method of claim 12, wherein an average and a variance of similarities of images for which a gender of the query facial image and a gender of the target facial image are determined to be identical are obtained and the obtained similarities are adjusted using the obtained average and variance of similarities.

14. A system for recognizing a face, the system comprising:
a gender classifying unit to classify genders of at least one respective face in a query facial image and a plurality of target facial images and to output a result of the gender classifying in terms of probabilities;
a gender reliability judging unit to judge a reliability of a classified gender of the at least one respective face in the query facial image and/or the plurality of target facial images using a respective probability;
a model selecting unit to select respective training models based on the gender classifying and the judged reliability;
a feature extracting unit to extract feature vectors from the query facial image and the target facial images using the selected training models; and
a recognizing unit to compare a feature vector of the query facial image and feature vectors of the target facial images to obtain similarities, and to recognize a person of the query facial image as being a same person as an identified target image having a largest similarity among the obtained similarities.

15. The system of claim 14, wherein the model selecting unit compares a determined gender of the query facial image with a determined gender of each of the target facial images with reference to a judged reliability of the query facial image, and selects a global model and a model, of a plurality of models, that corresponds to an identified same gender between the query facial images and the target facial images.

16. The system of claim 15, wherein the feature extracting unit projects the query facial image and each of the target facial images to projection spaces, each being formed by the global model and the model that corresponds to the identified same gender, to obtain a global feature vector and a gender feature vector for each image, and concatenates the global feature vector with the gender feature vector to output as a respective feature vector for each image.

17. The system of claim 14, wherein the model selecting unit selects only the global model based on a reliability of the classified gender of the query facial image.

18. The system of claim 17, wherein the feature extracting unit projects the query facial image and each of the target facial images to a projection space formed by only the global models, to obtain a global feature vector for each image, and outputs the obtained global feature vector as a respective feature vector for each image.

19. The system of claim 14, wherein the recognizing unit calculates inner products of the feature vectors of the query facial image and each of the feature vectors of the target facial images, respectively, and measures similarities by dividing the calculated inner products by a product of magnitudes of respective feature vectors of the query facial image and each of the target facial images.

20. The system of claim 19, wherein the recognizing unit calculates an average and a variance of similarities of images for which a gender of the query facial image and a gender of the target facial images are judged to be identical, and adjusts the obtained similarities using the obtained average and variance of similarities.

21. At least one medium comprising computer readable code to control at least one processing element to implement a method comprising:
classifying genders of at least one respective face in a query facial image and a current target facial image;
selecting a training model based on the classifying of the genders;
obtaining feature vectors of the query facial image and the current target facial image using the selected training model;
measuring a similarity between the feature vectors; and
obtaining similarities of a plurality of target facial images and recognizing a person of the query facial image as being a same person as an identified target image having a largest similarity among the obtained similarities.
